(19) United States
(12) Patent Application Publication
(10) Pub. No.: US 2007/0271131 A1
(43) Pub. Date: Nov. 22, 2007

(54) Method and system for lithographic and non-lithographic production process estimates and production specifications

(76) Inventor: David J. McCaskill, Washington, MO (US)

Correspondence Address: David J. McCaskill, 2515 Hwy. A, Washington, MO, 63090, US

(21) Appl. No.: 11/438,159

(22) Filed: May 22, 2006

(51) Int. Cl. G06F 17/30

(52) U.S. Cl. 705/10

(57) ABSTRACT

A method and system for automating lithographic and non-lithographic production process estimates and production specifications is described. A production calculator is coupled with a database management system. The production calculator contains a graphic user interface (GUI) generator, a function that logically selects a printing machine sheet size, a group of functions that calculate a number of printing impressions, a printing machine selection function, a group of functions that calculate pre-press production variables as they applies to a selected printing machine, a function that estimates ink usage, a function that calculates paper cutting, a function that calculates paper folding, and a function that saves estimate and production information to a database.

### BACKGROUND OF THE INVENTION

1. Field of the Invention

The present invention relates to automating lithographic and non-lithographic printing production process estimates and production specifications over a communications network.

2. Background Art

Estimating/quoting for the graphic arts industry, including lithographic and non-lithographic processes, is a means of establishing a price for a printed product or group of printed products by determining values for a variety of variables, including material and labor costs, to generate a gross cost figure. A profit margin or mark up value is then applied to the gross totals.

Currently, quoting is performed by persons, such as professional printing estimators or industry experts. Even quotes that are available over a communications network, such as a wide area network (WAN), require expert involvement. For example, printed product pricing is available on Internet websites in list form. An estimator prepares a list of common or popular printed product prices with price breaks for incremented quantities. For example, the per unit price for a quantity of 500 will typically be greater than the per unit price for a quantity of a 5000. The list can then be posted to an Internet website. A variation of this listing method is to store a pricing list in a database. The list can then be queried and displayed in a GUI (graphical user interface) or HTML (hypertext markup language) document. Alternatively, a quote can be obtained by submitting an HTML form that is processed by a professional estimator. The estimator manually prepares a quote for the quote request, and sends the quote to the requesting party.

Another method of obtaining printed product pricing is described in U.S. Pat. No. 6,526,423, titled “System and method for creating, generating and processing user-defined generic specs” (“the '423 patent”). The '423 patent describes a means of combining options to products that are pre-quoted by an industry expert.

Currently, quoting is limited by pre-assembled pricing lists in one form or another, or is limited to a correspondence between an industry expert and a requesting party.

Disadvantages of these types of quoting methods include inflexibility and time considerations. With regard to inflexibility, if any of the attributes necessary to pricing are not part of a provided list, there is no way to receive a price for the product unless some additional type of correspondence with the expert is undertaken. With regard to time considerations, significant amounts of time are required to interface with an industry expert, which can be detrimental to the quote requesting party, who may have an immediate need for printed product.

Thus, what is desired is a quoting system and method that does not suffer from the disadvantages described above, which include requiring a pre-assembled pricing list, requiring expert involvement, being inflexible, and requiring significant amounts of time to complete.

### BRIEF SUMMARY OF THE INVENTION

In aspects of the present invention, methods, systems and computer program products for improving the quoting/estimating process for lithographic and non-lithographic printing organizations are provided. Furthermore, in aspects, information regarding a specific printed product or a group of printed products is compiled. Embodiments of the present invention allow for printed products to be evaluated and processed without the involvement of a printing estimator professional or industry expert. Furthermore, a pre-assembled pricing list is not required.

In a first aspect, a server receives an input printing quote request from a computer system over a network communications link or connection. The connection/link may be a link of a wide area network (WAN), such as the Internet, a local area network (LAN), or other network or combination of networks. Typically, a user interacts with the computer system to input the quote request. The user may input the quote request into one or a series of input forms. The input forms may be interactive forms displayed in a graphical user interface, or other form types.

In a further aspect, a server application receives form data (e.g., from the computer system), and processes the received data to submit database queries in order to build record sets that are specific to the submitted data. The record sets and formatted form data are stored on a computer system as variable data. The variable data may be stored in any type of storage, including memory such as a random access memory (RAM).

In a still further aspect, a server application processes variable data to determine production information, such as selecting a printing machine sheet size (press sheet) and a printing machine (also referred to as a “printing press” or “press). During processing, production information is stored as variable data.

In another aspect, cost variable data is determined, and a profit margin may be applied to the cost variable data to produce a net total, if desired. A query is executed to store production information and net totals into a database as a new record and the quote information is displayed for the user.

These and other objects, advantages and features will become readily apparent in view of the following detailed description of the invention. Note that the Summary and Abstract sections may set forth one or more, but not all exemplary embodiments of the present invention as contemplated by the inventor.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an example of a server configuration.

FIG. 2 shows a server supplying a GUI using user information.

FIG. 3 shows a server processing a quote request.

FIG. 4 shows a system configuration in an example embodiment.

FIG. 5 shows an example of press sheet selection, where press sheets are selected using an indexing system, according to an example embodiment.

FIG. 6 shows an example of printing cost automation, in an example embodiment.

FIG. 7 shows an example of cutting cost automation, in an example embodiment.

FIG. 8 shows an example of printing pre-press cost automation, in an example embodiment.

FIG. 9 shows an example of folding production cost automation, in an example embodiment.

FIG. 10 shows an example of user quote pricing automation, in an example embodiment.

FIG. 11 shows an example of quoting information being saved as a new database record, in an example embodiment.

FIGS. 12 and 13 show flowcharts for generating printing quotes, according to example embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

Embodiments of the present invention provide ways of providing quotes/estimates to requesting parties for lithographic and non-lithographic printing organizations. Embodiments provide ways of compiling information about a specific printed product or a group of printed products. Embodiments of the present invention allow printed products to be evaluated and processed without the involvement of a printing estimator professional or industry expert. In an embodiment, a configuration may be specific to the printing organization that it illustrates. In another embodiment, a configuration may be general purpose.

A printing organization is an entity that prints desired print patterns on paper products for requesting entities (e.g., a user). For a particular print job or task, information is needed from the requesting party, including a paper type and an output paper size for the print task. Numerous paper brands are possible, including Cougar, Lynx, Husky, Boydun, classic linen, royal fiber, royal cotton, etc. Numerous further variations of paper are possible, including offset, gloss book, gloss cover, writing, text, bond, cover, etc. Further paper variables include size (e.g., length and width), weight, caliper, color, and price.

Paper may be supplied by paper manufacturers in a variety of sizes, which may be a same or different size than a size paper that may be input and processed by a particular printing machine. For example, a selected paper may be supplied in a size 11″×17″, while the printing machine may handle a maximum size of 8.5″×11″. Thus, in this example, the selected paper of 11″×17″ may need to be cut in half to fit in the printing machine. The paper supplied by the manufacturer (or otherwise available to a printing organization) is referred to herein as “parent paper” or “parent sheet.” Paper that is sized for a printing machine is referred to herein as “press paper” or “press sheet.” Parent sheet paper frequently must be downsized (e.g., cut in half, quartered, etc.) to become press sheet paper.

A printing machine receives the press sheet paper, and prints a print pattern desired by the requesting user on the press sheet paper, using one or more selected inks. In lithographic printing processes, the pattern printed on press sheet paper is formed by one or more “impressions.” The print pattern has a size or area. An impression involves the printing machine performing a single iteration of applying ink to the paper. A separate impression is typically performed for each color of ink. Impressions may be printed on one side or both sides of a particular press sheet. Furthermore, a single impression may used to form one print pattern, or multiple print patterns, in a side-by-side or array manner, if the press sheet paper is large enough for multiple copies of the print pattern. After printing, the press sheet may optionally be cut into separate pieces (e.g., if there is more than one print pattern on the press sheet). Furthermore, after separation, each print pattern may be folded one or more times, if the requesting user requests such folding.

A method and system for automating lithographic and non-lithographic production process estimates and production specifications are described. A production calculator is coupled with a database management system. The production calculator contains a graphic user interface (GUI) generator, and one or more functions. For instance, applicable functions include: (a) a function that logically selects a printing machine sheet size (i.e., press sheet); (b) a function that calculates a number of printing impressions; (c) a printing machine selection function; (d) a function that calculates pre-press production variables as they apply to a selected printing machine; (e) a function that estimates ink usage; (f) a function that calculates paper cutting; (g) a function that calculates paper folding; and (h) a function that saves estimate and production information to a database. Any one or more of these functions may be present in embodiments. These functions may be implemented as modules (separate or overlapping) in hardware, software, firmware, or any combination thereof.

Various individuals may prepare relevant information stored in a database that is accessed by embodiments. For example, an industry expert may create a database table containing printing machine information for all desired printing machines that would be used for a lithographic or non-lithographic printing organization. An industry expert may create a database table containing customer information. An industry expert may create a database table containing paper information. These tables may be created by these individuals, or other individuals (expert or non-expert).

Users access the production calculator by way of a public communications network, such as the Internet, or on a private network. The user submits an estimate request with the use of a GUI or other interface. The user enters information about a printed product on a generated GUI form. The GUI form contains information such as ink combinations on the front and/or back of the product, ink bleed, product size, folding, quantities, and/or other production related information.

After the form is submitted, the production calculator can process the estimate. The processed estimate and associated production information is then written to a database, and information is generated for the user with the estimated pricing per quantity.

In the discussion below, a printing organization is described by representing its physical makeup mathematically. The physical makeup of a printing organization is based on the equipment and equipment operation ability of the organization. Although a particular type of printing organization may be described below, this description is provided for illustrative purposes, and embodiments of the present invention are applicable to any type of printing organization or individual, and to other similar organizations or individuals, having any level of printing capability, as would be apparent to persons skilled in the relevant art(s) from the teachings herein.

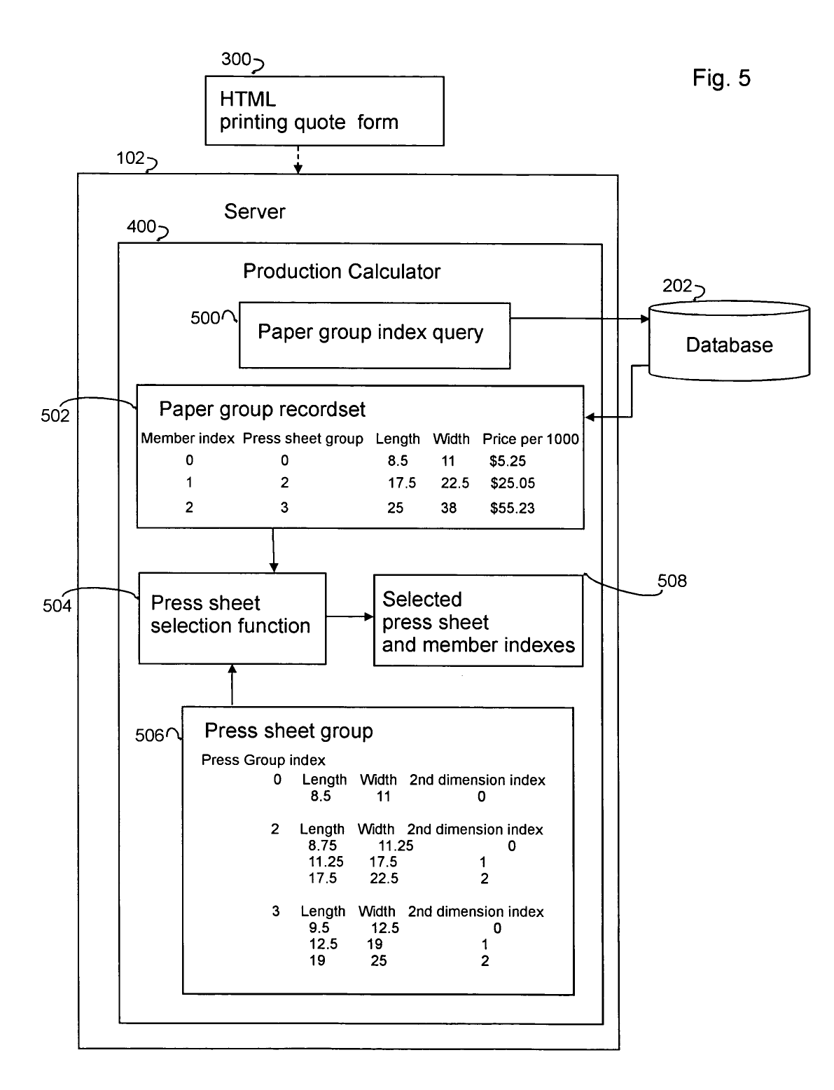

Furthermore, application functions (e.g., press sheet selection function 504 of FIG. 5) are described below. Such functions may be implemented as modules in hardware, software, firmware, or any combination thereof For example, in an embodiment, such functions may be implemented as JAVA scripts, or as modules of a C-language or other language program, which may be compiled, and which may be stored in a storage device. Such scripts/program may operate in a processor of a personal computer, a server, or any other type of computer system.

In this document, the terms “computer program medium” and “computer usable medium” are used to generally refer to media such as a removable storage unit, a hard disk installed in hard disk drive, or other type of storage, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

### Example Embodiments of the Present Invention

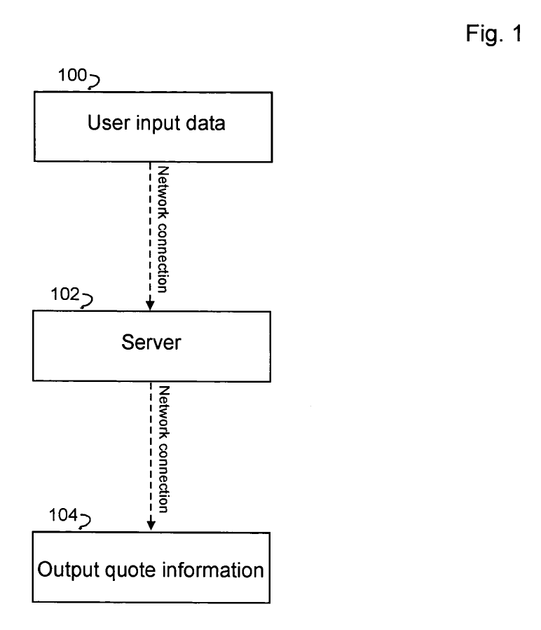

In an embodiment, a server receives an input printing quote request from a computer system over a network link. In an embodiment, the network link may be a link of a wide area network (WAN), such as the Internet, or any other communications link. FIG. 1 shows an example of a server 102 configured according to an embodiment of the present invention. As shown in FIG. 1, a user input data 100 is received by server 102 over a network connection/link, and server 102 generates an output quote information 104, which is also transmitted over a network connection/link. Server 102 includes a communications interface (wired or wireless) for communicating over the network connection/link(s).

For example, server 102 receives an input printing quote request, including user input data 100. User input data 100 may include production data for a print request. Server 102 processes the production data and outputs output quote information 104. Output quote information 104 can include a price for each requested quantity submitted by the user, a reference number to identify the quote and a description of the printed product, and further data. Embodiments allow for one or more forms to be used by a user to input user input data 100. For example, in one embodiment, all necessary data for a quote request can be input into one form. In another embodiment, multiple forms are used by the user to input user input data 100. For instance, more than one form may be used when prior input data can affect subsequent input data. An example of multiple data input forms, with prior data impacting later data, is described below, for illustrative purposes.

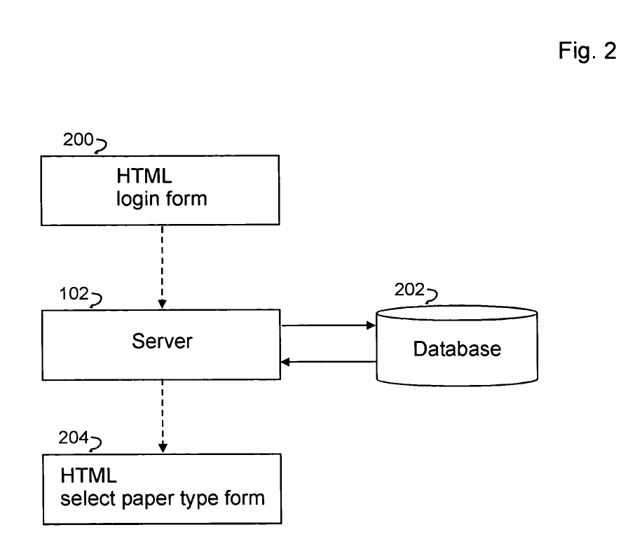

In an embodiment, a user interacts with a computer system to input user input data 100 of the quote request. The computer system may be any type of suitable computing system, including a desktop computer or a mobile computer (such as a laptop computer or a handheld computer such as a BLACKBERRY®, a PALM PILOT®, a personal digital assistant (PDA), etc.), or other mobile device (such as a cell phone). For example, the user interacts with an HTML form displayed by a graphical user interface (GUI) of the computer system. For instance, the HTML form may be HTML login form 200 of FIG. 2, which is filled out by the user to input a quote request. HTML login form 200 may include various data entry blanks, including an entry blank for a username and password.

For example, a user interacts with and submits HTML login form 200 to provide user information to initiate a new user session, and server 102 queries database 202 for runtime data. A user may need to re-supply the user information each time a session is initiated, or alternatively, an account may be provided/set up for the user, and thus the user may merely need to supply account login information (e.g., username and password).

Server 102 generates a HTML page with a paper type selection form 204. Paper type selection form 204 is a second form generated to allow the user to input data describing a paper. Database 202 includes a variety of paper types. Paper types represent groups of paper that share the same characteristics. For example “Gloss Cover” and “Bond” are two different paper types, but there are many different paper brands for each of these types. Selecting a paper type reduces the size of a paper record set query because the query doesn't need to query all of the paper in a database, only the selected type. Paper types that are available in database 202 can be displayed in a forms list box (or in other formats) in an HTML page such as paper type selection form 204. The user interacts with form 204, such as by selecting a paper type in form 204, and the selection can be submitted to server 102.

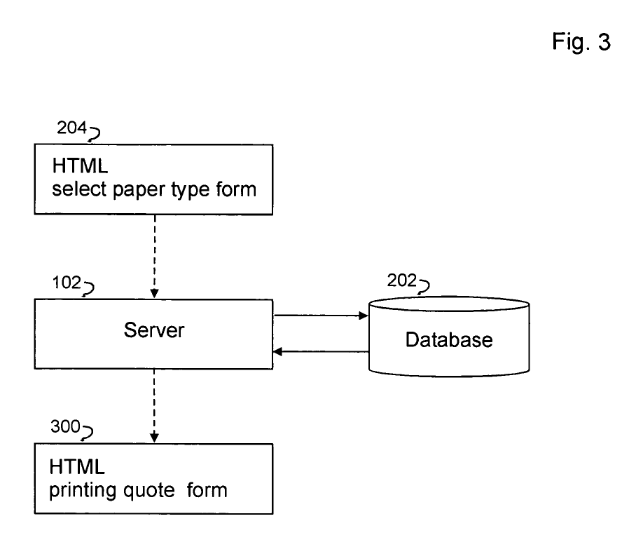

As described above, data collected from one or more input forms can be processed by a server to create a new input form. FIG. 3 shows server 102 processing data of paper type selection form 204 and data from database 202 to generate an HTML printing quote form 300. HTML printing quote form 300 is a third form that enables a user to enter data that describes a printed product. A user interacts with form 300 to input further data and/or further define previously input data. For example, HTML printing quote form 300 may include various data entry blanks based on the paper types entered in form 204, including a list selections (list box) and option input devices, including a list box for paper brand selection, a data entry blank for the size of the finished product, a data entry blank for the names of ink on the front and back of the product, a number of folds in one direction, a number of folds at a right angle to the first direction, and one or more data blanks for multiple quantities of paper that are desired.

A number of ink data entry blanks that are present in form 300 depends on the printing organization. If the printed product has printing that extends to an edge of the product, the ink must extend past the finished edge on the press sheet. This is known in the art as “bleed.” One or more HTML form check boxes in form 300 may be used to indicate bleed. The user may assign each ink a percentage of coverage by a list box in form 300 that is associated with each ink entry blank. The size of the printed product may be entered in an entry blank in form 300 for length and an entry blank for width. An HTML list box could be used for the measurement system in form 300. For example, the user could select inches or centimeters as a measurement type. However, a measurement type other than inches or centimeters could be used.

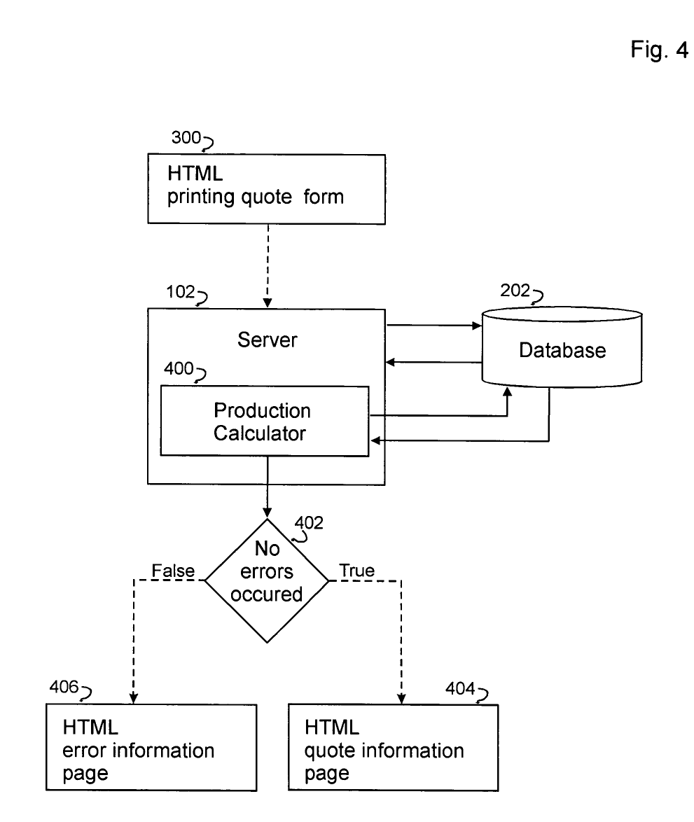

According to an embodiment of the present invention, HTML printing quote form 300 enables a user to input data that describes one or more requested printed products. A server interacts with a database and a server application to generate output data or error information. FIG. 4 shows HTML printing quote form 300 submitted to provide entered data to server 102. Server 102 may provide submitted data of HTML printing quote form 300 to an application operating on server 102, such as a production calculator 400. Production calculator 400 may be implemented in hardware, software, firmware, or any combination thereof. Production calculator 400 uses data of HTML printing quote form 300 and of database 202 to process a user quote request, and may generate error information. Production calculator 400 determines whether an error occurred after submission of form 300, as indicated at decision 402. If an error is not determined to have occurred, an HTML quote information page 404 is generated with quote information (e.g., as described further below). If one or more errors are determined to have occurred, an HTML error information page 406 is generated with error information.

In an example, HTML printing quote form 300 includes data from database 202 obtained according to a paper type selection in HTML select paper type form 204. Server 102 may use data submitted by the user from HTML printing quote form 300 and data from database 202. At this point, server 102 has information that describes a printed product or products in such a detailed way that production calculator 400 can evaluate and process the quote request of the user. Server 102 can pass data upon execution of production calculator 400. Production calculator 400 can run additional queries of database 202 to provide more detailed data and production data, if desired. Production calculator 400 evaluates the quote request data. If the quote request data is valid, production calculator 400 can process and fulfill the quote request by passing quote information to HTML quote information page 404.

Valid data is defined by production rules. Production rules are set according to the constraints of the particular organization. For example, the largest printed sheet producible by a printing organization may be smaller than the printed product size that was entered as request data in HTML printing quote form 300, which would cause an error. Thus, the printing organization may not be capable of producing the requested print job. Production calculator 400 handles invalid data as an error. Information regarding the error is provided in HTML error information page 406. Thus, in this example, HTML error information page 406 may state that the printed product is too large for the printing organization. Further errors due to input information can be handled in a similar fashion.

Embodiments of the present invention enable selection of a printing machine sheet size (press sheet) and selection of a printing machine, such as sheet fed-type printing machines. A sheet fed printing machine prints on individual sheets of paper, as opposed to printing from a roll of paper. In further embodiments, roll fed printing machines may be handled in a similar manner.

According to an embodiment, a server application function selects optimum press sheet sizes corresponding to a user quote request. FIG. 5 illustrates an example of press sheet selection by server 102. HTML printing quote form 300 submits data to server 102 that describes one or more printed products. Server 102 interacts with database 202, and production calculator 400 processes HTML printing quote form 300 to select press sheet sizes.

In an embodiment, production calculator 400 queries database 202 using a paper group index query 500 to create a paper group record set 502. Production calculator 400 generates paper group index query 500 by determining and assigning to it an index based on user data input into HTML printing quote form 300. Production calculator 400 evaluates the data input into form 300 to determine paper (one or more papers) appropriate to meet the criteria of the input data, and thereby determine the proper index for the paper. The index (“paper group index”) is used to retrieve data for the appropriate paper from database 202. In an embodiment, database 202 stores paper type data in an indexed manner, so that desired paper type data can be retrieved from database 202 using the assigned index.

Paper group index query 500 causes retrieval of the paper data of desired paper from database 202. A particular paper can have a variety of data attributes, including type, finish, brand name, weight, and color. Paper is available for purchase in various sheet sizes. Papers that share the same attributes, other than sheet size and price, are assigned the same paper group index in database 202.

As a result, paper group record set 502 lists a paper group. A paper group is a set of paper stocks that share the same attributes, such as type, finish, brand name, weight, and color, but do not share the same size. Paper group record set 502 includes information about a paper group and information about each member of the paper group. Each row of paper group record set 502 lists a different member of the paper group. Different members of the paper group have different sheet sizes and/or cost. Because the paper group index is the same for all of the members of a paper group, the paper group index is not shown in paper group record set 502 of FIG. 5. However, each row includes a second index (shown in the first column of record set 502 of FIG. 5) that identifies the member within the paper group and within database 202. Thus, in an embodiment, paper is indexed in database 202 by a first index (paper group index) and a second index (member index).

Paper group member information in record set 502 can include a length, width, price, the member index, and a press sheet group index (that refers to a press sheet group listed in press sheet group record 506). For example, paper group record set 502 (of FIG. 5) lists three paper group members, with a first row of set 502 listing a first paper group member having member index of “0”, a second row of set 502 listing a second paper group member having a member index of “1”, and a third row of set 502 listing a third paper group member having a member index of “2”. All of the paper group members of the paper group of record set 502 are evaluated by press sheet selection function 504, to determine which paper size to use to create printed product.

Press sheet selection function 504 uses data from paper group record set 502, press sheet group record 506, and a print pattern size (input by a user in HTML printing quote form 300) to select a press sheet and member index 508. Press sheet group record 506 lists press sheet sizes that the printing organization is capable of printing (e.g., capable of being fed into printing machines of the organization). Press sheet sizes are listed in press sheet group record 506 in groups (“press sheet groups”). Press sheet groups have a maximum size and a size relationship among members. The maximum size is the largest member of the press sheet group that a printing organization can feed through their largest printing machine. The sizes of members of a press sheet group are related in that other members are bisections of the largest member of the group. In other words, a press sheet group listing three members may list a largest sized member, a middle sized member having half the size of the largest member, and a smallest member having half the size of the middle sized member. In this example, the size of the middle sized member can be obtained by folding the largest sized member in half, and the size of the smallest sized member can be obtained by folding the middle sized member in half.

For example, press sheet group record 506 of FIG. 5 lists three press sheet groups, respectively having press sheet group indexes of “0,” “2, and “3.” Each indexed press sheet group can include representative data, such as a length, a width, and a second dimensional index. The second dimensional index is optional, and may be used by press sheet selection function 504 to iterate press sheet sizes, as described below. The first press sheet group of index “0” includes a press sheet size of: 8.5″×11″, having a second dimensional index of “0”. The second press sheet group of index “2” includes press sheet sizes of 8.75″×11.25″, 11.25″×17.5″ and 17.5″×22.5″, which have respective second dimensional indexes of 0, 1, and 2. The press sheet sizes of the second press sheet group are bisections of each other. The third press sheet group of index “3” includes press sheet sizes of: 9.5″×12.5″, 12.5″×19″ and 19″×25″, which have respective second dimensional indexes of 0, 1, and 2. The press sheet sizes of the third press sheet group are bisections of each other.

Press sheet group record 506 may be previously prepared by the printing organization, based on their knowledge of possible print sizes by the printing organization, and stored in server 102, database 202, or elsewhere, for access by press sheet selection function 504.

As shown in FIG. 5, each member of paper group record set 502 is assigned a press sheet group index (second column). The press sheet group index is assigned for a press sheet group listing a size matching, or a bisection of, a size listed for the paper group member in record set 502. For example, the first row/member index “0” of record set 502 lists a size of 8.5″×11″, which is also contained in the press sheet group in press sheet group record 506 having press sheet group index “0”. Thus, the first row/member index “0” of record set 502 lists press sheet group index “0”. The second row/member index “1” of record set 502 lists a size of 17.5″×22.5″, which is also contained in the press sheet group in press sheet group record 506 having press sheet group index “2”. Thus, the second row/member index “1” of record set 502 lists press sheet group index “2”. The third row/member index “2” of record set 502 lists a size of 25″×38″, which is not specifically listed in a press sheet group of record 506. However, the sizes listed in the press sheet group having press sheet group index “3” in press sheet group record 506 are bisections of 25″×38″. Thus, the third row/member index “2” of record set 502 lists press sheet group index “3”. These assignments of press sheet group indexes to members of record set 502 can be performed by production calculator 400, or can be pre-assigned in database 202.

Press sheet selection function 504 selects a press sheet size from press sheet group record 506 to be used to print the print pattern defined in HTML printing quote form 300 on a paper of paper group record set 502. In an embodiment, press sheet selection function 504 iterates the press sheet groups of press sheet group record 506 with the corresponding members of record set 502, until a suitable selection of paper and press sheet size is determined. For example, in an embodiment, a nested loop function, having a first (outer) loop based on press sheet group index, and a second (inner) loop based on the second dimensional index of press sheet group record 506, can be used. In other embodiments, press sheet selection function 504 can iterate press sheet groups and paper group members in other ways, as would be known by persons skilled in the relevant art(s).

For instance, the example of paper group record set 502 and press sheet group record 506 shown in FIG. 5 can be iterated by function 504 as follows. Assume for the purposes of the present example that a user requested a print job for 1000 copies of a print pattern having a size of 8.5″×11,″ and requiring 4 colors of ink on two sides of the paper. Thus, a maximum total number of impressions for the print job=1000 (copies)×4 (inks)×2 (sides)=8000 impressions.

The row of record set 502 having member index 0 is iterated first. Member index 0 lists a parent paper size of 8.5″×11″ and a press sheet group index of 0. In record 506, the press sheet group of index 0 lists a single press sheet size of 8.5″×11″ for second dimensional index 0. For the example print job, because the print pattern is 8.5″×11″, a single printing of the print pattern can be made on each sheet of the press sheet paper. Furthermore, 1000 (copies of the print pattern)÷1 (print pattern per parent paper)=1000 sheets of parent paper required. A number of required impressions for member index 0, press group index 0, and second dimensional index 0=1000 (copies)×4 (inks)×2 (sides)=8000 impressions.

The row of record set 502 having member index 1 is iterated next. Member index 1 lists a parent paper size of 17.5″×22.5″ and a press sheet group index of 2. In record 506, the press sheet group of index 2 lists three press sheet sizes. The press sheet size of 8.75″×11.25″ of second dimensional index 0 is iterated first. Because the print pattern is 8.5″×11″, a single printing of the print pattern can be made on each sheet of the press sheet paper. A number of required impressions for member index 1, press group index 2, and second dimensional index 0=1000 (copies)×4 (inks)×2 (sides)=8000 impressions. Furthermore, 1000 (copies of the print pattern)÷4 (print patterns per parent paper)=250 sheets of parent paper required.

The next press sheet size of the press sheet group having index 2 is 11.25″×17.5″. Because this press sheet size has second dimensional index 1, it is iterated next. Because the print pattern is 8.5″×11″, and the press sheet paper is 11.25″×17.5″, two printings of the print pattern can be made on each sheet of the press sheet paper. Thus, only 500 copies of this press sheet paper are needed. Thus, a number of required impressions for member index 1, press group index 2, and second dimensional index 1=500 (copies)×4 (inks)×2 (sides)=4000 impressions. Again, 1000 (copies of the print pattern)÷4 (print patterns per parent paper)=250 sheets of parent paper required.

The next press sheet size of the press sheet group having index 2 is 17.5″×22.5″. Because this press sheet size has second dimensional index 2, it is iterated next. Because the print pattern is 8.5″×11″, and the press sheet paper is 17.5″×22.5″, four printings of the print pattern can be made on each sheet of the press sheet paper. Thus, only 250 copies of this press sheet paper are needed. Thus, a number of required impressions for member index 1, press group index 2, and second dimensional index 2=250 (copies)×4 (inks)×2 (sides)=2000 impressions. Again, 1000 (copies of the print pattern)÷4 (print patterns per parent paper)=250 sheets of parent paper required.

The row of record set 502 having member index 2 is iterated next. Member index 2 lists a parent paper size of 25″×38″ and a press sheet group index of 3. In record 506, the press sheet group of index 3 lists three press sheet sizes. The press sheet size of 9.5″×12.5″ of second dimensional index 0 is iterated first. Because the print pattern is 8.5″×11″, a single printing of the print pattern can be made on each sheet of the press sheet paper. A number of required impressions for member index 2, press group index 3, and second dimensional index 0=1000 (copies)×4 (inks)×2 (sides)=8000 impressions. Furthermore, 1000 (copies of the print pattern)÷8 (print patterns per parent paper)=125 sheets of parent paper required.

The next press sheet size of the press sheet group having index 3 is 12.5″×19″. Because this press sheet size has second dimensional index 1, it is iterated next. Because the print pattern is 8.5″×11″, and the press sheet paper is 12.5″×19″, two printings of the print pattern can be made on each sheet of the press sheet paper. Thus, only 500 copies of this press sheet paper are needed. Thus, a number of required impressions for member index 2, press group index 3, and second dimensional index 1=500 (copies)×4 (inks)×2 (sides)=4000 impressions. Again, 1000 (copies of the print pattern)÷8 (print patterns per parent paper)=125 sheets of parent paper required.

The next press sheet size of the press sheet group having index 3 is 19″×25″. Because this press sheet size has second dimensional index 2, it is iterated next. Because the print pattern is 8.5″×11″, and the press sheet paper is 19″×25″, four printings of the print pattern can be made on each sheet of the press sheet paper. Thus, only 250 copies of this press sheet paper are needed. Thus, a number of required impressions for member index 2, press group index 3, and second dimensional index 2=250 (copies)×4 (inks)×2 (sides)=2000 impressions. Again, 1000 (copies of the print pattern)÷8 (print patterns per parent paper)=125 sheets of parent paper required.

In an embodiment, press sheet selection function 504 selects a paper of paper group record set 502 and a press sheet size from press sheet group record 506 based on the calculations performed for each combination of paper and press sheet above. Any of the combinations may be selected, based on a designated criteria of the particular printing organization. For example, press sheet selection function 504 may perform a paper and press sheet selection based on a “maximum number of impressions” rule. The maximum number of impressions rule is a number determined by a printing organization to select a desired balance between paper size and press sheet size. A number for the maximum number for impressions rule (hereinafter “impressions rule”) is selected by the printing organization.

For instance, in the above example, the number for the impressions rule may be set to 6000. Press sheet selection 504 iterates paper sizes and press sheets in the order illustrated above. In other words, members in paper group record set 502 are ordered from smallest (e.g., 8.5″×11″) to largest (e.g., 25″×38″), and thus are iterated in this order. The press sheets in each group of press sheet group record 506 are also ordered from smallest to largest. Furthermore, the press sheet groups are ordered in press sheet group record 506 from the group having the smallest maximum sized member (e.g., index 0, having 8.5″×11″ as its maximum press sheet) to the group having the largest maximum sized member (e.g., index 3, having 19″×25″ as its maximum press sheet). Thus, paper sheet group record 506 is iterated by paper sheet group index, and within each paper group, by second dimensional index, as illustrated above.

In such a configuration, the impressions rule may be set to a relatively low number to favor a relatively smaller parent sheet paper size, and alternatively be set to a relatively high number to favor a relatively larger parent sheet paper size.

In the above example, press sheet selection function 504 will iterate as shown in Table 1 as follows, until the impressions rule (if any) is exceeded:

TABLE 1

| Member | Press Sheet | Second Dimensional | |
|---|---|---|---|
| Index | Group Index | Index | Impressions |
| 0 | 0 | 0 | 8000 |
| 1 | 2 | 0 | 8000 |
| 1 | 2 | 1 | 4000 |
| 1 | 2 | 2 | 2000 |
| 2 | 3 | 0 | 8000 |
| 2 | 3 | 1 | 4000 |
| 2 | 3 | 2 | 2000 |

Without setting a value for the impressions rule, or if the impressions rule is set relatively very high (e.g., 10000), press sheet selection function 504 will complete all of the iterations shown in Table 1, finishing with the last row having member index 2, press group index 3, and second dimensional index 2, and the last row will be selected. Thus, the paper of the third row of record set 502, size 25″×38″, having member index 2 is selected. Further, the press sheet of the third row of the third press sheet group of press sheet group record 506, having a press sheet size of 19″×25″, is selected. As described above, in such case, a number of 2000 impressions would be used.

If a value of 5000 for the impressions rule is used, press sheet selection function 504 will iterate as shown in Table 1, from top toward the bottom, until a number of iterations is reached that is less than 5000. Thus, function 504 would stop iterating after completion of iterating row 3 of Table 1, with member index 0, press sheet group index 2, and second dimensional index of 1. Thus, the paper of the second row of record set 502, size 17.5″×22.5″, having member index 1 is selected. Further, the press sheet of the second row of the second press sheet group of press sheet group record 506, having a press sheet size of 11.25″×17.5″, is selected. As described above, in such case, a number of 4000 impressions would be used.

If a value of 1000 for the impressions rule is used, press sheet selection function 504 will iterate as shown in Table 1, from top toward the bottom, until a number of iterations is reached that is less than 1000. Thus, function 504 would stop iterating after completion of iterating row 1 of Table 1, with member index 0, press sheet group index 0, and second dimensional index of 0. Thus, the paper of the first row of record set 502, size 8.5″×11″, having member index 0 is selected. Further, the press sheet of the first row of the first press sheet group of press sheet group record 506, having a press sheet size of 8.5″×11.5″, is selected. As described above, in such case, a number of 8000 impressions would be used.

Thus, in the above three examples of iterations according to Table 1, decreasing the impressions rule from 10,000, to 5000, to 1000, lead to increasing larger parent sheet paper sizes to be selected.

Thus, in the embodiment described above, press sheet selection function 504 uses a nested loop (a primary loop that runs an inner loop) to evaluate the number of impressions for each press sheet. The primary loop uses the press sheet group index from paper group record set 502 to select a press group index from press sheet group record 506. The inner loop uses the second dimension index of press sheet group record 506 to run a number of impressions function. Press sheets length and width are passed to the number of impressions function and the number of impressions is returned. If the number of impressions function returns a number of impressions less than the number of impressions rule then the loop is stopped and press sheet selection function 504 returns the two indexes where the nested loop stopped. If the number of impressions function returns a number of impressions more than the number of impressions rule, then the inner loop is incremented to the next second dimension index and the process is repeated. If the inner loop reaches the last second dimension index of the press group index and is not stopped, then the primary loop is incremented to the next member index of paper group record set 502.

The impressions rule value can be adjusted to better suit certain production situations. For example, a particular printing machine may be well suited for jobs with specific attributes. For instance if a printing machine were well suited for smaller sheets, such as 8.5″×11″ with black ink on one side, then the impressions rule value could be set to a higher value. As described above, setting the impressions rule to a higher value causes the loop of press sheet selection function 504 to end at smaller press sheet sizes more frequently. The impressions rule can be set to favor other press sheet sizes as well, based on user input information. When used, the impressions rule provides a way of controlling production conditions, as will become more apparent with respect to a printing machine selection function described below.

In an embodiment, press sheet selection function 504 steps through the data of press sheet group record 506 by the use of two-dimensional arrays (press sheet group record 506), where the first dimension index corresponds to press sheet group index from paper group record set 502 and the second dimension index corresponds to ascending press sheet sizes.

If all press sheet sizes have been tested using the impressions function, the last press sheet iterated will be the press sheet selection. In the current embodiment, the last press sheet will be the largest sheet of that press sheet group, because the press sheet sizes are indexed from smallest to largest as is the press sheet groups. In an embodiment, it the final iterated press sheet can contain the same number of print patterns (“number up”) as a previously iterated press sheet, then the first sheet with the same “number up” will be the press sheet selection. This is to insure that the least amount of paper is used. Production calculator 400 runs the press sheet selection function 504 for each quantity input by a user into the input forms (e.g., HTML printing quote form 300). Selected press sheets and member indexes 508, which includes the selected press sheet and the selected paper (by member index), can be stored in memory as variable data during run time.

Furthermore, in the above example, production calculator 400 determines a cost of the quantity of parent sheet paper required to accomplish the requested print job. The quantity of parent sheet paper required can be multiplied by a cost factor. For example, paper group record set 502 shows a cost per 1000 sheets of parent sheet paper for each member the paper group. Production calculator 400 can calculate parent paper costs as shown in Table 2 as follows, for each member of paper group record set 502:

TABLE 2

| Member | | Price per | Parent Paper |
|---|---|---|---|
| Index | Quantity | 1000 | Cost |
| 0 | 1000 | $5.25 | $5.25 |
| 1 | 250 | $25.05 | $6.26 |
| 2 | 125 | $55.23 | $6.90 |

The parent sheet paper cost value for the particular parent sheet paper selected by press sheet selection function 504 when determining the press sheet size can be used. For example, if the parent paper of member index 1 is selected, the cost of the required quantity of parent paper is 250 sheets at $25.05 per 1000 sheets=$6.26.

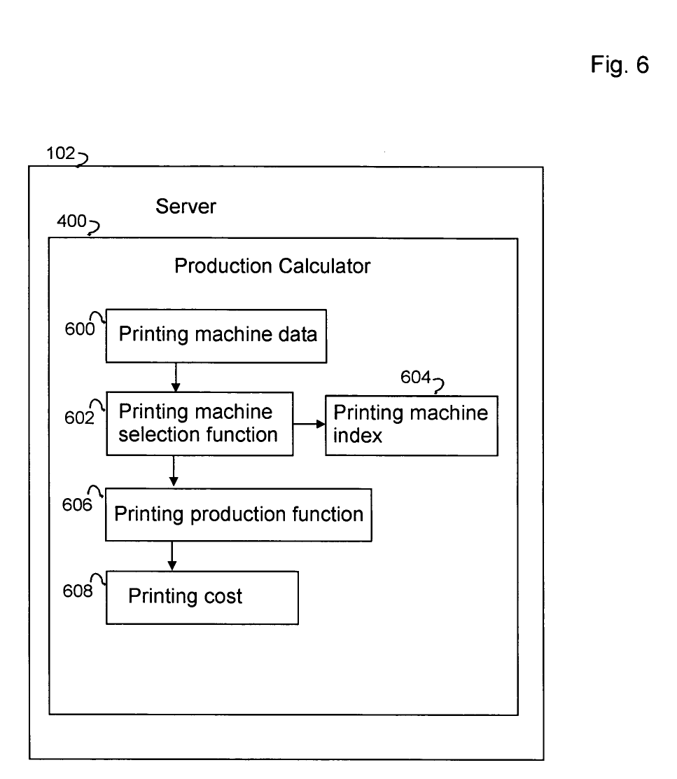

In a further embodiment, a server application function can select an optimum printing machine corresponding to a selected press sheet. FIG. 6 shows an example of the selecting of a printing machine and of determining a printing cost, as performed by production calculator 400. Printing machine data 600 is evaluated by a printing machine selection function 602 of production calculator 400. Using selected printing machine data of printing machine data 600, printing production function 606 calculates a printing cost 608 for each quantity of printed product. Printing machine data 600 is data that can exist as database data or as embedded application data. Data of printing machine data 600 includes a description of one or more physical attributes of printing machines, as well as limitations of printing machines. The evaluation of printing machine attributes can be physical attributes, as well as the ability of the printing machine operators. Printing machines that are represented within printing machine data 600 may be organized by indexes. Printing machine selection function 602 evaluates printing machine data 600 to eliminate any printing machines that are incapable of producing the requested printed product. For example, any printing machine that has a maximum press sheet size less than the selected press sheet size would be eliminated from the printing machine selection process.

Printing machines may also be eliminated for production reasons that may favor other printing machines. The maximum number of impressions rule value can be used to directly or indirectly affect operation of printing machine selection function 602 because press sheet sizes can impact printing machine elimination. If the maximum number of impressions rule value is set relatively lower, smaller press sheet sizes are selected more frequently. Thus, smaller printing machines would be excluded less frequently. Printing machine selection function 602 can then select a printing machine based on production attributes. For example, a first printing machine may have the ability to run more impressions per hour than a second printing machine. However, the first printing machine may take longer to prepare a job to run (set up). The printing machine selection in this example is determined by the optimum number of impressions for the first printing machine. The optimum number of impressions is the point at which printing machine run time offsets a setup cost. Each printing machine has an optimum number of impressions value. The optimum number of impressions value can be stored in printing machine data 600. Printing machine selection function 602 generates a printing machine index 604. Printing production function 606 uses data from printing machine data 600 that corresponds to printing machine index 604. Printing machine data 600, data of database 202, and data from HTML printing quote form 300 are used by printing production function 606 to generate printing cost 608, which may include a cost for set up time, run time, operator cost, etc.

Cutting machines are used to cut group member parent paper sheets into press sheets and to cut printed product from the press sheets. In general, a cutting machine includes a knife, a clamp, and a flat table with an adjustable backstop, but can be configured differently. A cutting portion of the cutting machine is mounted around the table as to form an opening through which paper can be inserted. At the top of the opening is the clamp and knife. The machine is operated by placing a stack of paper through the opening to the back stop. A cutting machine operator can then apply the clamp and draw the knife through the paper. Note that embodiments are also applicable to cutting machines that operate in a more fully automated manner.

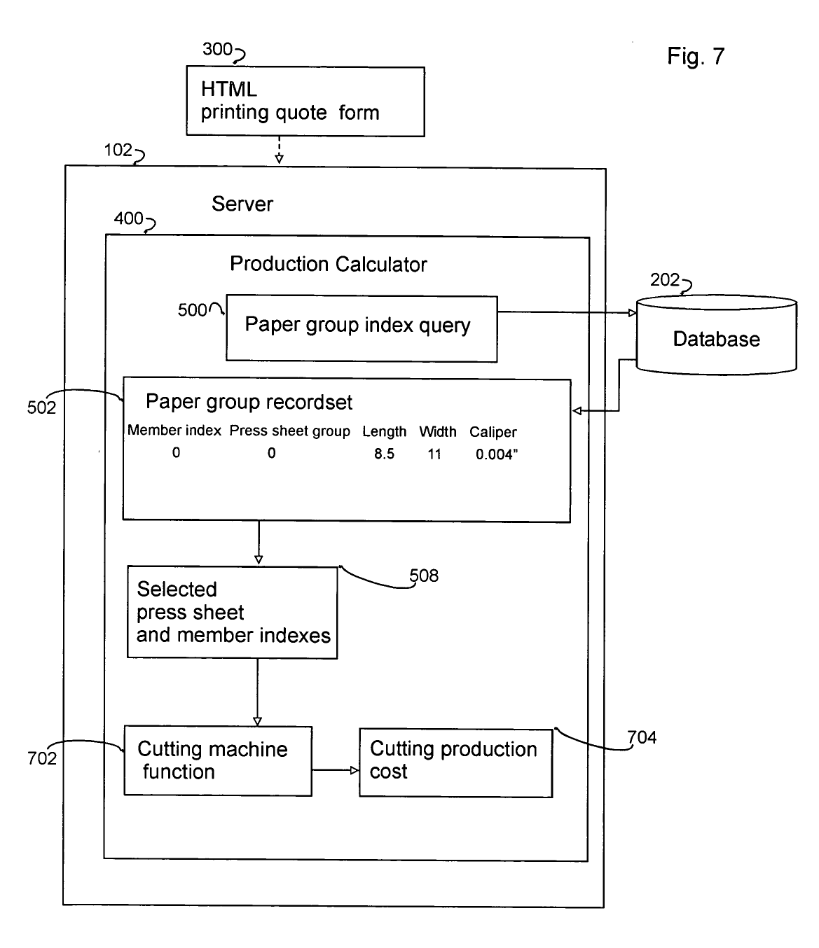

In an embodiment, a server application function can calculate a cutting production cost by using runtime database data. FIG. 7 shows an example of the determining of cutting cost. Production calculator 400 generates selected press sheet and member indexes 508, as described above. Cutting machine function 702 receives selected press sheet and member indexes 508 to access data relating to information necessary to calculate cutting production cost. Such information includes paper thickness, paper size, product size and bleed information. Using selected press sheet and member indexes 508 a cutting machine function 702 calculates a production cost for cutting, which can be stored in a cutting production cost record 704. Cutting machine function 702 takes into account the parent paper sheet stock and press sheet sizes determined by press sheet selection function 504 of FIG. 5. Cutting machine function 702 calculates a number of cuts required to produce the press sheets from the parent paper sheet stock, a number of cuts required to separate the finished printed pattern size from the press sheets, and if the image bleeds, the extra cuts to remove the bleed (gutter) portion from the printed product. A cost amount (e.g., dollar figure) for cutting production cost record 704 can be determined by cutting machine function 702 based on a predetermined cost per cut (including potentially different costs for different types of cuts) multiplied by the number of cuts (for each type of cut) that are determined.

In an embodiment, cutting machine function 702 also calculates a number of “cut lifts”. A cut lift is the maximum quantity of paper that a cutting machine will cut (in a stack) based on thickness. Thus the number of cut lifts is the number of times a cutting machine is loaded with paper. A cost for cut lifts can be added into the cost amount of cutting production cost 704, by multiplying the number of cut lifts by a predetermined cost per cut lift.

Further factors that can impact a cutting cost include the selected parent paper group member sheets total thickness per quantity, the selected press sheet thickness per quantity, the press sheets orientation as it relates to its position on the group member sheet, the printed product orientation as it relates to its position on the press sheet, the number of press sheets within a group member sheet, and the number of printed product within a press sheet.

Printing pre-press costs are specific to the printing machine that was selected by printing machine selection function 602. Not all printing machines share the same pre-press attributes. Some printing machines require almost no pre-press labor or material while others have an extensive pre-press cost factor. Some elements of pre-press cost include art and typesetting, raster image processing, photographic film processing, film assembly and litho plate processing. Some printing machines require the use of photographic film and or litho plates. Photographic film (usually negative image), is used in lithography to transfer an image to a litho plate. Litho plates can be coated with a high contrast photographic emulsion. The negative film is placed in contact with the plate emulsion and a light source exposes the plate emulsion. The plate is then developed leaving a positive ink receptive image on its surface.

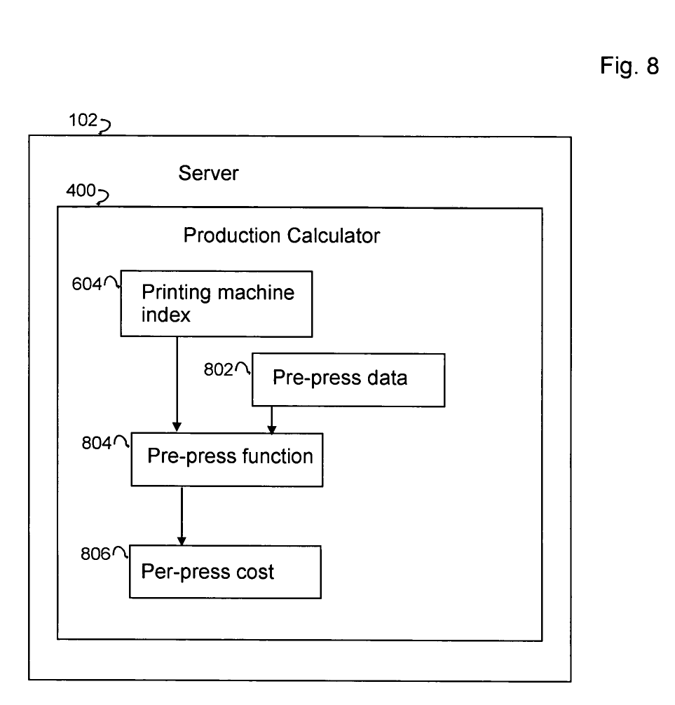

In an embodiment, a server application function can return a pre-press cost by evaluating printing machine specific data. FIG. 8 shows an example of the determining of a printing pre-press cost. In the example of FIG. 8, production calculator 400 executes a pre-press function 804. Pre-press function 804 receives printing machine index 604 of FIG. 6, which pre-press function 804 uses to determine one or more specific printing machines, from which pre-press function 804 generates pre-press data 802. Pre-press function 804 determines what pre-press costs apply to a printing quote by comparing pre-press data 802 with data describing the printed product or products. For example, with respect to a printing machine that uses film and litho plates, pre-press function 804 can determine an amount of film needed because the printed product size, the number up, and the number of ink colors on front and back of the printed product have been established. By processing pre-press data 802, pre-press function 804 generates pre-press cost record 806. Pre-press cost record 806 includes a cost amount based on predetermined costs for the various pre-press factors related to the printing machine(s) and printed product(s).

Folding machines are used in the Graphic Arts Industry in a variety of ways. Some example uses for folding machines include perforating, scoring, slitting, gluing, and folding of paper products. Folding machines are used by placing a stack of paper in a sheet feeder at one end of the folding machine. In one example folding machine, the folding machine feeds one sheet of paper at a time onto a conveyer. The conveyer transfers the paper to a configuration of buckle devices. A buckle device has an adjustable backstop. The backstop is adjusted to set the width of the fold. After the first fold the sheet of paper can be transferred to another buckle device via rollers. A gate on the buckle device will keep the sheet from being folded if another fold is not desired. When the sheet has traveled through all buckle devices and rollers it can be transferred onto a second conveyer. The second conveyer can be set at a right angle to the first set of buckle devices. The second conveyer can then transfer the sheet into another set of buckle devices. This will cause the sheet to fold at a right angle to the first fold. Embodiments of the present invention are applicable to any type of folding machine, including this example folding machine.

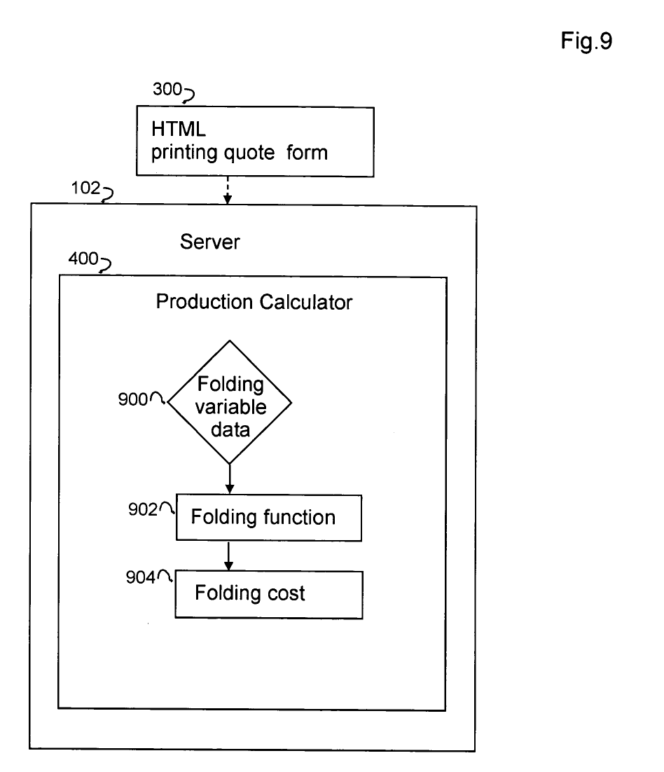

In an embodiment, a server application function can generate a cost of folding a printed product by processing user input data. FIG. 9 shows an example of the determining of a folding production cost. Production calculator 400 determines whether folding data was submitted by HTML printing quote form 300. If any folding variable data 900 is provided, production calculator 400 executes a folding function 902. Folding function 902 processes a folding variable data 900 and generates a folding cost record 904. Folding function 902 calculates folding cost record 904 by using the number of folds the user entered in HTML printing quote form 300, including data for folds in a first direction and folds at a right angle to the first direction, multiplying each fold type by a predetermined cost, and summing the determined costs for each fold type.

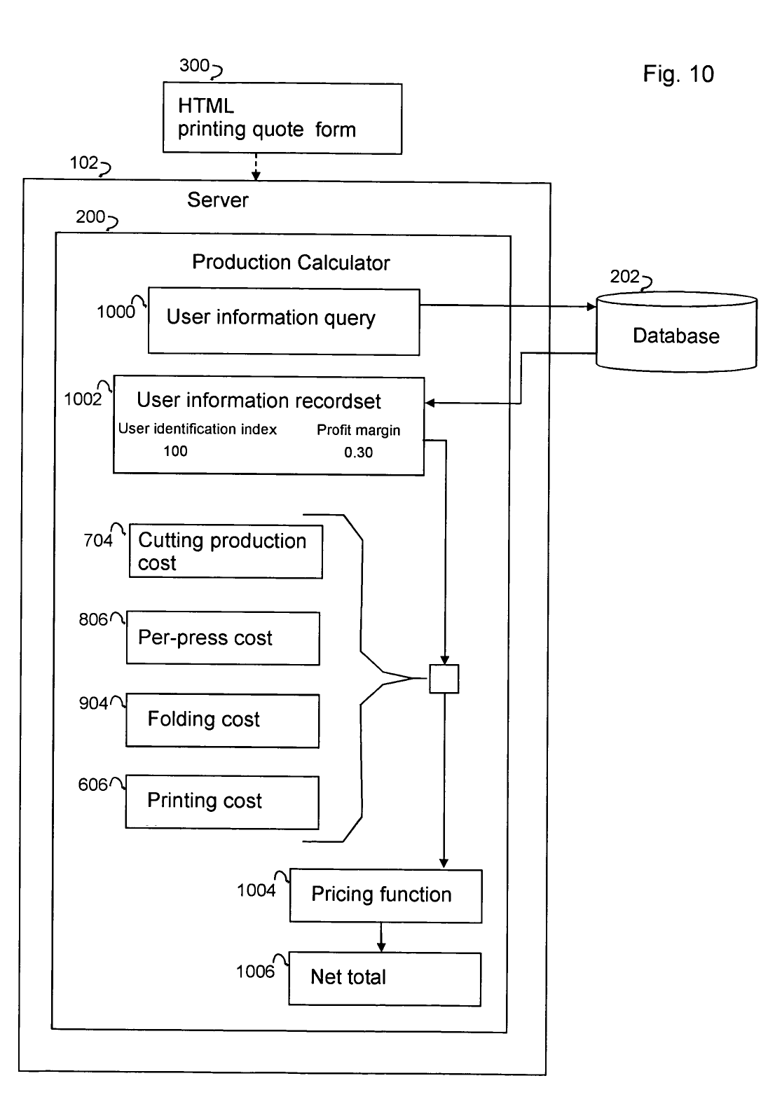

In an embodiment, the server application functions described herein generate a group of production costs, which can be summed in server 102. A profit margin or mark-up can be added to the sum of the production costs to produce a net total. Alternatively a profit margin or markup could be applied at different levels to individual costs prior to generating a net total. FIG. 10 shows an example of a quote pricing determination using production calculator 400. Production calculator 400 submits a user information query 1000 using a user identification index from a submitted HTML printing quote form 300. The sum of printing 606 of FIG. 6, cutting production cost record 704 of FIG. 7, pre-press cost record 806 of FIG. 8, and folding cost record 904 of FIG.9 are used by a pricing function 1004, along with an optional profit margin value to generate a net total 1006. In this example, a user information record set 1002 contains the user identification index and a floating point numeral that represents a margin of profit that will be applied to the gross total. Additional profit margin fields could be used to correspond to different levels of gross totals or other aspects of material. Pricing function 1004 runs for each quantity of printed product input by a user into the input forms that desire a quote.

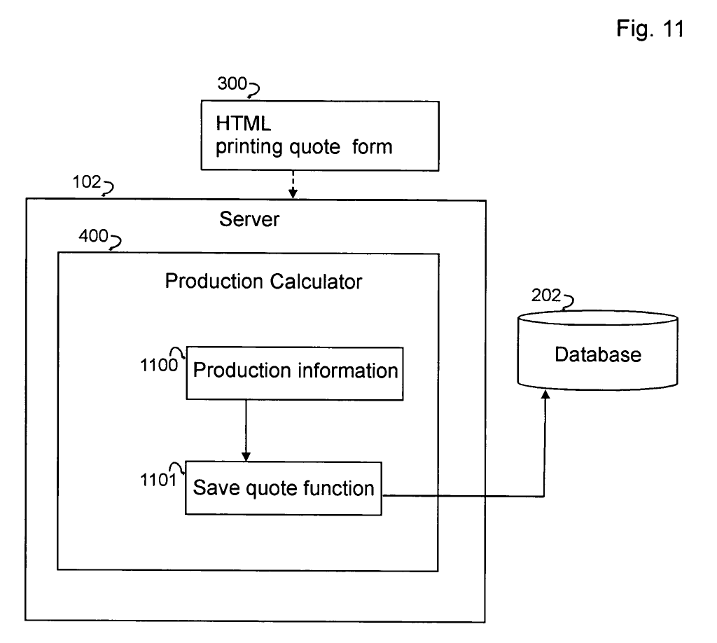

In an embodiment, a server application function runs an insert record query to save quote information in a database. The saved data includes information regarding a user requested quote and information pertinent to the production of a printed product or products. FIG. 11 shows an example of quoting information being saved as a new database record.

Production calculator 400 executes a save quote function 1101 using a user identification index from a submitted HTML printing quote form 300 and variable data of a production information record 1100. Production information of production information record 1100 can be compiled in memory as the quote is processed. Example production information that may be pertinent to a quoting method includes user information, information that describes the printed product or products, quantities of product, a printing machine index, etc.

It is apparent that any and/or all of the data used to process a user quote request may be saved in storage, at any point in time, if desired.

Embodiments of the present invention can have a variety of configurations. Server application functions can be added or removed according to the particular printing organization. In an embodiment, a server receives an input quote request from a computer system over an Internet link. A server application processes the input quote request using one or more server application functions, such as described above, to provide output information to the user.

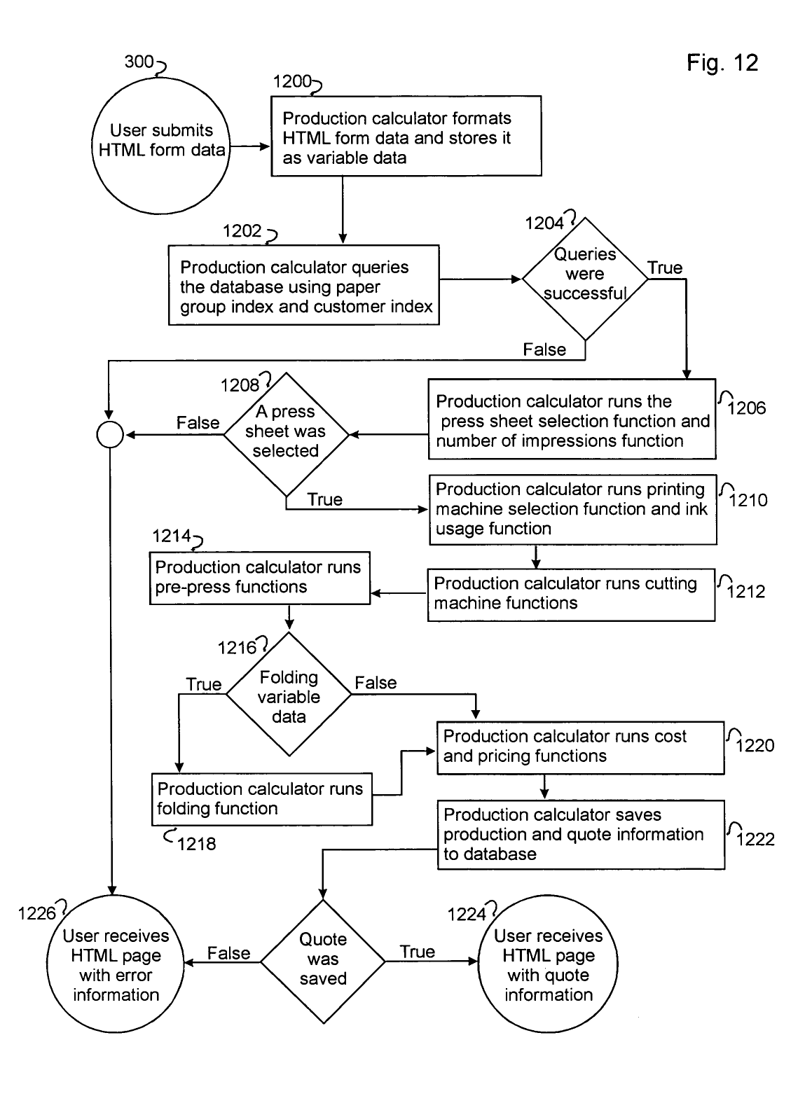

FIG. 12 shows a flowchart that illustrates an example embodiment for generating a pricing quote. Other structural and operational embodiments will be apparent to persons skilled in the relevant art(s) based on the following discussion. The steps shown in FIG. 12 do not necessarily have to occur in the order shown.

As shown in FIG. 12, a user submits a HTML printing quote form 300, which is received by a production calculator at a server (such as production calculator 400 of server 102).

In step 1200, HTML printing quote form 300 is formatted and stored in RAM as variable data.

In step 1202, a database is queried using a paper group index and a customer index.

For example, production calculator 400 may perform the query. Record sets are thereby generated from the variable data.

In step 1204, the database queries are evaluated to determine if any errors occurred. If database queries were unsuccessful, operation proceeds to step 1226, where an HTML page is generated with error information 406 and the process ends. If the database queries were successful, the process proceeds to step 1206.

In step 1206, a press sheet selection function and number of impressions function is performed. For example, the press sheet selection function may be performed by press sheet selection function 504 of production calculator 400, as described above. If more than one quantity was submitted from HTML printing quote form 300, the press sheet selection functions of step 1206 may run in a loop for each quantity. Any error that occurs in the press sheet selection function may terminate the process.

In step 1208, if a press sheet is not selected, operation proceeds to step 1226. If a press sheet is selected, operation proceeds to step 1210.

In step 1210, the printing machine selection and ink usage functions are performed. For example, these functions may be performed by printing machine selection function 602 and printing production function 606 of production calculator 400, as described above. Operation then proceeds to step 1212.

In step 1212, one or more cutting machine functions are performed. For example, these may be performed by cutting machine function 702 of production calculator 400, as described above.

In step 1214, a pre-press function is performed. For example, this may be performed by pre-press function 804 of production calculator 400, as described above.

In step 1216, it is determined whether any folding variable data exists. If folding variable data is present, operation proceeds to step 1218. If folding variable data is not present, operation proceeds to step 1220.

In step 1218, a folding function is performed. For example, this function may be performed by folding function 902 of production calculator 400, as described above. Operation proceeds to step 1220.

In step 1220, cost and pricing functions are performed. For example, these functions may be performed by pricing function 1004 of production calculator 400, as described above.

In step 1222, production and quote information is saved to a database. For example, this information may be saved to database 202. If the quote is successfully saved, operation proceeds to step 1224. If the quote is not successfully saved, operation proceeds to step 1226.

In step 1224, the user receives a page with quote information. For example, in an embodiment, the quote information is provided in HTML quote information page 404, which may be displayed at the user's computer system.

In step 1226, an HTML page is generated with error information. For example, in an embodiment, the error information is provided in HTML error information page 406, which may be displayed at the user's computer system.

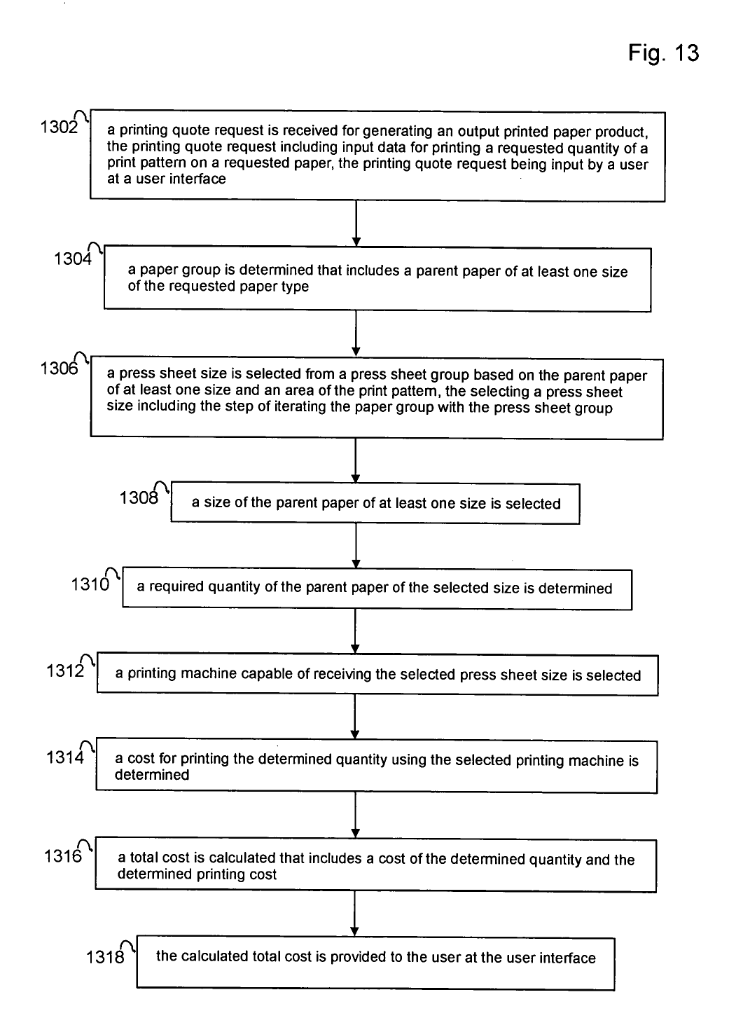

FIG. 13 shows a flowchart 1300 that illustrates another example embodiment for generating a pricing quote. For example, the steps of flowchart 1300 may occur in server 102 or other type of computer system. Other structural and operational embodiments will be apparent to persons skilled in the relevant art(s) based on the following discussion. The steps shown in FIG. 13 do not necessarily have to occur in the order shown.

Flowchart 1300 starts with step 1302. In step 1302, a printing quote request is received for generating an output printed paper product, the printing quote request including input data for printing a requested quantity of a print pattern on a requested paper, the printing quote request being input by a user at a user interface. For example, as described above, a printing quote request may be received that includes an area of a print pattern, a quantity of the print pattern to be printed, a type of paper on which to print the print pattern, and/or other input data.

In step 1304, a paper group is determined that includes a parent paper of at least one size of the requested paper type. For example, as described above, a paper group may be determined, such as shown in FIG. 5 for paper group record set 502, that lists a type of parent paper that fulfills the type of paper requested in step 1302 in one or more different sizes (and prices).

In step 1306, a press sheet size is selected from a press sheet group based on the parent paper of at least one size and an area of the print pattern, the selecting a press sheet size including the step of iterating the paper group with the press sheet group. For example, as described above, member of the paper group of paper group record set 502 can be iterated, one-by-one, with the press sheet sizes listed in press sheet group record 506.

In step 1308, a size of the parent paper of at least one size is selected. For example, as described above, a parent paper member can be selected from the paper group of record set 502 as a result of the iterations that occur in step 1306, or in another manner.

In step 1310, a required quantity of the parent paper of the selected size is determined. For example, as described above, a quantity of the parent paper can be determined, having a desired quantity and size of the printed pattern. For instance, the quantity can be determined as the desired quantity of the printed pattern divided by the number of printed patterns that can fit on a sheet of the parent paper. Alternatively, the quantity can be determined as the desired quantity of the printed pattern divided by the number of press sheets per parent paper sheet, further divided by the number of printed patterns per press sheet.

In step 1312, a printing machine capable of receiving the selected press sheet size is selected. For example, as described above, the printing machine may be selected by printing machine selection function 602.

In step 1314, a cost for printing the determined quantity using the selected printing machine is determined. For example, as described above, the cost for printing may be determined by printing production function 606.

In step 1316, a total cost is calculated that includes a cost of the determined quantity and the determined printing cost. For example, the total cost, including the paper cost, printing cost, and/or further costs, can be calculated by production calculator 400.

In step 1318, the calculated total cost is provided to the user at the user interface.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. For example, although the forms described above are indicated as HTML forms, it would be apparent to persons skilled in the relevant art(s) that the forms could be alternative form types, and/or can be provided in other manners (e.g., printouts). Thus, the breadth and scope of the present invention should not be limited by any of the above-described exemplary embodiments, but should be defined only in accordance with the following claims and their equivalents.

What is claimed is:

1. A method for generating a printing production quote in a computer system, comprising:
receiving at the computer system a printing quote request for generating an output printed paper product, the printing quote request including input data for printing a requested quantity of a print pattern on a requested paper, the printing quote request being input by a user at a user interface;
determining a paper group that includes a parent paper of at least one size of the requested paper type;
selecting a press sheet size from a press sheet group based on the parent paper of at least one size and an area of the print pattern, said selecting a press sheet size including the step of iterating the paper group with the press sheet group;
selecting a size of the parent paper of at least one size;
determining a required quantity of the parent paper of the selected size;
selecting a printing machine capable of receiving the selected press sheet size;
determining a cost for printing the determined quantity using the selected printing machine;
calculating a total cost that includes a cost of the determined quantity and the determined printing cost; and
providing the calculated total cost to the user at the user interface.

2. The method of claim 1, further comprising:
calculating a cost for cutting the determined quantity of the parent paper to the selected press sheet size and for cutting the print pattern from press sheet paper of the selected press sheet size; and
wherein said calculated total cost further includes the calculated cutting cost.

3. The method of claim 1, further comprising:
determining a pre-press cost due to the selected printing machine; and
wherein said calculated total cost further includes the determined pre-press cost.

4. The method of claim 1, wherein the input data includes folding data, further comprising:
calculating a cost for folding the output paper product according to said folding data; and
wherein said calculated total cost further includes the calculated folding cost.

5. The method of claim 1, wherein said calculated total cost further includes a profit margin.

6. The method of claim 1, wherein said iterating includes:
(1) determining a required number of impressions for a first press sheet size of the press sheet group and a first parent paper of the paper group; and
(2) repeating step (1) for at least one further combination of press sheet size of the press sheet group and parent paper of the paper group.

7. The method of claim 6, wherein step (2) is terminated after a required number of impressions is determined that exceeds an impressions rule value.

8. The method of claim 1, wherein said step of determining a paper group includes querying a database using a determined paper group index.

9. The method of claim 1, further comprising:
enabling at least one form to displayed in a graphical user interface of a second computer system into which the user inputs the input data; and
wherein said receiving step comprises receiving the printing quote request at the first computer system from the second computer system over a communications network.

10. The method of claim 9, further comprising:
processing the data input into the at least one form, including the steps of:
(1) formatting the data input into the at least one form into a plurality of data types; and
(2) storing the formatted input data in random access memory (RAM) as variable data.

11. A computer program product comprising a computer usable medium having computer readable program code means embodied in said medium for generating a printing production quote, said computer readable program code means comprising:
a first computer readable program code means for enabling a processor to receive a printing quote request from a user including input data for printing a requested quantity of a print pattern on a requested paper to generate an output printed paper product;
a second computer readable program code means for enabling a processor to determine a paper group including parent paper of at least one size of the requested paper type;
a third computer readable program code means for enabling a processor to select a press sheet size from a press sheet group based on the parent paper of the at least one size and an area of the print pattern, said third computer readable program code means including computer readable program code means for enabling a processor to iterate the paper group with the press sheet group;
a fourth computer readable program code means for enabling a processor to select a size of the parent paper;
a fifth computer readable program code means for enabling a processor to determine a required quantity of the parent paper of the selected size;
a sixth computer readable program code means for enabling a processor to select a printing machine capable of receiving the selected press sheet size;
a seventh computer readable program code means for enabling a processor to determine a cost for printing the determined quantity using the selected printing machine;
an eighth computer readable program code means for enabling a processor to calculate a total cost that includes a cost of the determined quantity and the determined printing cost; and
a ninth computer readable program code means for enabling a processor to provide the calculated total cost to the user at the user interface.

12. The computer program product of claim 11, further comprising:
a tenth computer readable program code means for enabling a processor to calculate a cost for cutting the determined quantity of the parent paper to the selected press sheet size and for cutting the print pattern from press sheet paper of the selected press sheet size; and
wherein said calculated total cost further includes the calculated cutting cost.

13. The computer program product of claim 11, further comprising:
a tenth computer readable program code means for enabling a processor to determine a pre-press cost due to the selected printing machine; and
wherein said calculated total cost further includes the pre-press cost.

14. The computer program product of claim 11, wherein the input data includes folding data, further comprising:
a tenth computer readable program code means for enabling a processor to calculate a cost for folding the output paper product according to said folding data; and
wherein said calculated total cost further includes the calculated folding cost.

15. The computer program product of claim 11, wherein said calculated total cost further includes a profit margin.

16. The computer program product of claim 11, wherein said computer readable program code means for enabling a processor to iterate includes:
a computer readable program code means for enabling a processor to determine a required number of impressions for a first press sheet size of the press sheet group and a first parent paper of the paper group; and
a computer readable program code means for enabling a processor to repeat determining a required number of impressions for at least one further combination of press sheet size of the press sheet group and parent paper of the paper group.

17. The computer program product of claim 16, wherein said computer readable program code means for enabling a processor to repeat determining a required number of impressions includes computer readable program code means for enabling a processor to terminate the repeating after a required number of impressions is determined that exceeds an impressions rule value.

18. The computer program product of claim 11, further comprising:
a tenth computer readable program code means for enabling a processor to enable at least one form to displayed in a graphical user interface of a computer system to enable the user to input the input data; and
wherein said first computer readable program code means comprises computer readable program code means for enabling a processor to receive the printing quote request from the computer system over a communications network.

19. A server, comprising:
a communications interface configured to receive a printing quote request, the printing quote request including input data for printing a requested quantity of a print pattern on a requested paper to generate an output printed paper product, the printing quote request being input by a user at a user interface; and
a production calculator configured to determine a paper group that includes parent paper of the requested paper type of at least one size;
wherein the production calculator includes:
a press sheet selection module configured to select a press sheet size from a press sheet group based on the parent paper and an area of the print pattern, wherein said press sheet selection module is configured to iterate the paper group with the press sheet group, to select a size of the parent paper, and to determine a required quantity of the parent paper of the selected size;
a printing machine selection module configured to select a printing machine capable of receiving the selected press sheet size; and
a printing production module configured to determine a cost for printing the determined quantity using the selected printing machine;
wherein said production calculator is further configured to calculate a total cost that includes a cost of the determined quantity and the determined printing cost; and
wherein said communications interface is configured to provide the calculated total cost to the user at the user interface.

20. The server of claim 19, further comprising:
a cutting machine module configured to calculate a cost for cutting the determined quantity of the parent paper to the selected press sheet size;
a pre-press module configured to calculate a pre-press cost due to the selected printing machine; and
a folding module configured to calculate a cost for folding the output paper product according to folding data of the input data;
